(19) United States
(12) Patent Application Publication
(10) Pub. No.: US 2025/0096237 A1
(43) Pub. Date: Mar. 20, 2025

(54) MULTI-LAYER CATHODE FOR RECHARGEABLE BATTERIES AND METHOD FOR MAKING SAME

(71) Applicants: International Business Machines Corporation, Armonk, NY (US); Sidus Energy, Inc., Milpitas, CA (US)

(72) Inventors: Phillip Medina, San Jose, CA (US); Maxwell Giammona, Fremont, CA (US); Linda Karin Sundberg, Los Gatos, CA (US); Han Zhen, Jiangsu Province (CN)

(21) Appl. No.: 18/370,091

(22) Filed: Sep. 19, 2023

(51) Int. Cl. H01M 4/36; H01M 4/02; H01M 4/04; H01M 4/136; H01M 4/1397; H01M 4/58; H01M 4/62; H01M 4/66; H01M 10/0568; H01M 10/0569

(52) U.S. Cl. CPC H01M 4/366; H01M 4/0404; H01M 4/136; H01M 4/1397; H01M 4/582; H01M 4/622; H01M 4/625; H01M 4/661; H01M 10/0568; H01M 10/0569; H01M 2004/028; H01M 2300/0037

(57) ABSTRACT

A rechargeable battery with a multi-layer cathode has high active material loading, high-rate capability, high specific capacity, and low cell impedance. The multi-layer cathode has a first electrode layer with at least one adhesion promoting binder and at least one first conductive additive with an electrochemical surface area ≥800 m²/gm, which is prepared as a slurry and is applied to a cathode current collector; and a second binder with at least one polymeric binder that participates in a complexation interaction with at least halogen or at last one metal halide active material and at least one second conductive additive with a conductivity ≥5 S/cm, which is prepared as a slurry and is coated over the first electrode layer. The at least one halogen or metal halide active material, which is dissolved in water or alcohol for application, may be dosed into either the first or second electrode layer slurry. Additional electrode layers may have the same or a different formulation as the second electrode layer, with or without the active material.

### JOINT RESEARCH AGREEMENT

The subject matter of this disclosure describes activities undertaken within the scope of a joint research agreement that was in place before the effective date of the instant application. The parties to the joint research agreement are International Business Machines Corporation (Armonk, New York, USA) and Sidus Energy, Inc. (Milpitas, California, USA).

### TECHNICAL FIELD

The present invention relates generally to rechargeable batteries, and more specifically to a multi-layer cathode with a high wt % of active material loading that may be used to fabricate a rechargeable battery with high-rate capability, high specific capacity, and low cell impedance.

### BACKGROUND OF THE INVENTION

Rechargeable batteries are high in demand for a wide range of applications, from small batteries for industrial and medical devices, to larger batteries for electric vehicles and grid energy storage systems. Each application requires a specific set of electrochemical performance characteristics and in many critical and growing application species today, such as EVs, the battery performance remains a major limiting factor for satisfying the high standard of performance required to meet customers' needs.

The most widely used rechargeable batteries are lithium-ion batteries (LIBs). Currently used commercial LIBs have a metal oxide or metal phosphate-based lithium intercalation material as the positive electrode and a carbon-graphite-based intercalation material as the negative electrode. As the LIB is charged and discharged, lithium ions move back and forth between the positive and negative electrodes through a liquid electrolyte. Despite the rapid growth and success of LIBs, these batteries have shortcomings that have prevented LIBs from moving forward into a wider range of applications; these shortcomings include the low energy density of the batteries and the high cost of cathode materials, such as cobalt and nickel. There remains a need in the art for a low cost and high energy battery than can replace LIBs in a wide range of applications.

One alternative to conventional LIBs are metal halogen batteries, which have superior rate capability in comparison to LIBs. One type of metal halogen battery with a lithium metal anode and an iodine-based cathode has achieved a high specific capacity (180-200 mAh/g_{Iodine}) and a high-rate capability (a charging C-rate >5 C); however, this type of battery has the shortcomings of requiring large amounts of conductive additive (>40 wt %). Accordingly, there remains a need in the art for a battery that simultaneously has high specific capacity, high-rate capability, and conductive additive amounts low enough to achieve a high energy density.

### SUMMARY OF THE INVENTION

The present invention overcomes the need in the art with a rechargeable battery comprising a multi-layer cathode that supports >50 wt % loading of at least one halogen or metal halide active material and that produces a battery with high-rate capability, high specific capacity, and low cell impedance.

In one embodiment, the present invention relates to a rechargeable battery comprising: an anode; a cathode current collector; a multi-layer cathode comprising (i) at least one halogen or metal halide active material, (ii) a first electrode layer in contact with the cathode current collector, wherein the first electrode layer comprises at least one adhesion promoting binder and at least one first conductive additive with an electrochemical surface area ≥800 m²/gm, and (iii) a second electrode layer coated over the first electrode layer, wherein the second electrode layer comprises at least one polymeric binder that participates in a complexation interaction with the at least one halogen or metal halide active material and at least one second conductive additive with a conductivity ≥5 S/cm; and an electrolyte in contact with the anode and the cathode; and an electrolyte in contact with the anode and the cathode.

In another embodiment, the present invention relates to a rechargeable battery comprising: a lithium-containing anode; a stainless-steel cathode current collector; a two-layer cathode comprising (i) lithium iodide as an active cathode material, (ii) a first electrode layer in contact with the cathode current collector, wherein the first electrode layer comprises at least two adhesion promoting binders and at least two first conductive additives with an electrochemical surface area ≥800 m²/gm, and (iii) a second electrode layer coated over the first electrode layer, wherein the second electrode layer comprises at least one polymeric binder that participates in a complexation interaction with the lithium iodide active material and at least one second conductive additive with a conductivity ≥5 S/cm; and an electrolyte in contact with the anode and the cathode; a liquid electrolyte comprising at least one organic solvent and at least one ionic salt in contact with the anode and the cathode; and an oxidizing gas in contact with the anode, the cathode, and the liquid electrolyte.

In a further embodiment, the present invention relates to a method of fabricating a multi-layer cathode for a rechargeable battery comprising: preparing a first slurry comprising at least one adhesion promoting binder and at least one first conductive additive with an electrochemical surface area ≥800 m²/gm; dosing at least one halogen or metal halide active material solubilized in water or alcohol into the first slurry; applying the first slurry with the active material to a cathode current collector to form a first electrode layer of a multi-layer cathode; preparing a second slurry comprising at least one polymeric binder and at least one second conductive additive with a conductivity ≥5 S/cm; and coating the second slurry over the first electrode layer to form a second electrode layer of the multi-layer cathode.

In another embodiment, the present invention relates to a method of fabricating a multi-layer cathode for a rechargeable battery comprising: preparing a first slurry comprising at least one adhesion promoting binder and at least one first conductive additive with an electrochemical surface area ≥800 m²/gm; applying the first slurry to a cathode current collector to form a first electrode layer of a multi-layer cathode; preparing a second slurry comprising at least one polymeric binder, at least one second conductive additive with a conductivity ≥5 S/cm, and at least one halogen or metal halide active material solubilized in water or alcohol; and coating the second slurry over the first electrode layer to form a second electrode layer of the multi-layer cathode.

In a further embodiment, the at least one adhesion promoting binder of the first electrode layer is selected from the group consisting of sodium carboxymethylcellulose (CMC), styrene-butadiene rubber (SBR), polyvinylidene difluoride (PVDF), polyamide-imide (PAI) resin, and combinations thereof.

In another embodiment, the at least two adhesion promoting binders of the first electrode layer are sodium carboxymethylcellulose and styrene-butadiene rubber.

In a further embodiment, the at least one first conductive additive of first electrode layer is selected from the group consisting of graphene, conductive carbon black, carbide-derived carbon, Ketjen black, and combinations thereof.

In another embodiment, the at least two first conductive additives of first electrode layer are graphene and Ketjen black.

In a further embodiment, the at least one polymeric binder of the second electrode layer is selected from the group consisting of amylose, amylopectin, cellulose, xylan, chitin, chitosan, alginic acid, glycogen, poly(vinyl) acetate (PVAc), poly(vinyl) alcohol (PVA), poly(vinyl) pyrrolidone (PVP), nylon, polyaniline (PANI), polypyrrole (PPy), poly(vinyl) pyridine, polyacrylonitrile (PAN), polyacetylene (PA), poly phenylacetylene (PPA), polyphenylene vinylene (PPV), polythiophene (PT), alpha-cyclodextrin, beta-cyclodextrin, poly(3,4-ethyenedioxythiophene) polystyrene sulfonate (PEDOT: PSS), poly(2-dimethylamino)ethyl methacrylate) methyl chloride quaternary salt (MADQUAT), poly(diallyl dimethylammonium chloride) (PDADMAC), and combinations thereof.

In another embodiment, the at least one polymeric binder of the second electrode layer is poly(vinyl) pyrrolidone (PVP).

In a further embodiment, the at least one second conductive additive of the second electrode layer is selected from the group consisting of conductive carbon black, single-walled carbon nanotubes, graphite, graphene, carbon black, activated carbon, carbon fibers, carbide-derived carbon, Ketjen black, and combinations thereof.

In another embodiment the at least one second conductive additive of the second electrode layer is Ketjen black.

In a further embodiment, the at least one halogen or metal halide active material is incorporated into the first electrode layer.

In another embodiment, the active cathode material is lithium iodide, which is incorporated into the first electrode layer.

In a further embodiment, the at least one halogen or metal halide active material is incorporated into the second electrode layer.

In another embodiment, the active cathode material is lithium iodide, which is incorporated into the second electrode layer.

In a further embodiment, the multi-layer cathode includes one or more additional electrode layers having a composition similar to the second electrode layer.

In another embodiment, the rechargeable battery further comprises an oxidizing gas in contact with the anode, the cathode, and the electrolyte.

In a further embodiment, the oxidizing gas is selected from the group consisting of oxygen, air, nitric oxide, nitrogen dioxide, and combinations thereof.

In another embodiment, the active material is a metal halide with a mono-iodide or poly-iodide salt.

In a further embodiment, the electrolyte is a liquid electrolyte comprising at least one organic solvent and at least one ionic salt.

In another embodiment, the at least one organic solvent is selected from the group consisting of 1,2-dimethoxyethane (DME), tetraglyme (G4), 1,3-dioxolane (DOL), tetrahydrofuran (THF), ethyl acetate, acetonitrile, dimethylformamide (DMF), dimethyl sulfoxide (DMSO), acetone, hexamethylphosphoric triamide (HMPA), and combinations thereof.

In a further embodiment, the ionic salt is selected from the group consisting of lithium nitrate (LiNO₃), lithium bix(oxalate)-borate (LiBOB), lithium bis(trifluoromethanesulfonyl)imide (LiTFSI), lithium bis(fluorosulfonyl)imide (LiFSI), lithium hexafluorophosphate (LiPF₆), and combinations thereof.

In another embodiment, the anode comprises a material selected from the group consisting of carbon, graphite, silicon, lithium (Li), sodium (Na), potassium (K), calcium (Ca), zinc (Zn), aluminum (Al), vanadium (V), iron (Fe), and combinations thereof.

In a further embodiment, the cathode current collector comprises a material selected from the group consisting of aluminum (Al), copper (Cu), nickel (Ni), titanium (Ti), stainless steel, and combinations thereof.

Additional aspects and/or embodiments of the invention will be provided, without limitation, in the detailed description of the invention that is set forth below.

### BRIEF DESCRIPTION OF THE DRAWINGS

FIG. 1 is a graph showing rate performance at 0.5 C, 1 C, and 2 C for a rechargeable lithium-iodine battery with a two-layer cathode at 60% active material loading.

FIG. 2 is a graph showing rate performance at 0.5 C, 1 C, and 2 C for a rechargeable lithium-iodine with a single-layer cathode at 64% active material loading.

FIG. 3 is a graph that overlays the rate performance graphs of FIGS. 1 and 2.

FIG. 4 is a graph showing the specific capacity at 2-3.8 working electrode potential for a rechargeable lithium-iodine with a two-layer cathode at 71% active material loading.

FIG. 5 is a graph showing the specific capacity at 2-3.8 working electrode potential for a rechargeable lithium-iodine with a single-layer cathode at 74% active material loading.

FIG. 6 is a graph showing the cell impedance of a rechargeable LIB with a two-layer cathode at 71% active material loading.

FIG. 7 is a graph showing the cell impedance of a rechargeable LIB with a single-layer cathode at 74% active material loading.

FIG. 8 is a graph showing the coulombic efficiency of a battery with a two-layer cathode after five forming cycles at 0.5 C and 196 post-formation cycles at 1 C.

### DETAILED DESCRIPTION OF THE INVENTION

Set forth below is a description of what are currently believed to be preferred aspects and/or embodiments of the claimed invention. Any alternates or modifications in function, purpose, or structure are intended to be covered by the appended claims. As used in this specification and the appended claims, the singular forms “a,” “an,” and “the” include plural referents unless the context clearly dictates otherwise. The terms “comprise,” “comprised,” “comprises,” and/or “comprising,” as used in the specification and appended claims, specify the presence of the expressly recited components, elements, features, and/or steps, but do not preclude the presence or addition of one or more other components, elements, features, and/or steps.

As used herein, the term “battery” refers to an energy storage device that converts chemical energy into electrical energy. The basic components of a battery comprise an anode, a cathode, and an electrolyte, which are assembled to form the battery in a “stack” that is contained within a battery case to form a battery cell. The batteries described herein are rechargeable batteries where the stack is sealed within a battery cell case, which may be a button cell (e.g., 303/357; 11.6 mm diameter×5.4 mm height), a coin cell (e.g., CR2032, 20 mm diameter×3.2 mm height), a SWAGELOK® cell (Swagelok Co., Solon, OH, USA), a cylindrical cell (e.g., 18650, 18 mm diameter×65 mm height), a prismatic cell (rectangular with a steel or aluminum casing), or a pouch cell (typically rectangular with flexible polymer aluminum casing). It is to be understood that in some applications, multiple battery cells may be required to generate sufficient energy to power a device; thus, as used herein, the term “battery cell” may be used to refer to a single battery unit whereas the term “battery” refers more generally to all energy storage devices, including single battery cells and energy storage devices that require multiple battery cells for operation.

As used herein, the term “anode” refers to the negative electrode of a battery cell that transfers electrons to an external circuit through oxidation during discharging, and receives them from an external circuit and is reduced during charging.

As used herein, the term “cathode” refers to the positive oxidizing electrode of a battery cell that receives electrons from an external circuit, is reduced during discharging, and transfers the electrons to an external circuit through oxidation during charging.

As used herein, the terms “metal halide” and “metal halide salt” refer to compounds having a metal and a halogen. The metals of metal halides may be any metal in Groups 1 to 16 of the periodic chart but will typically be Group 1 alkali metals or Group 2 alkaline earth metals. Examples of Group 1 alkali metals include, without limitation, lithium (Li), sodium (Na), potassium (K), rubidium (Rb), cesium (Cs), and francium (Fr). Examples of Group 2 alkaline earth metals include, without limitation, beryllium (Be), magnesium (Mg), calcium (Ca), strontium (Sr), barium (Ba), and radium (Ra). The halides of the metal halides will be any halogen in Group 17 of the periodic chart, which include, without limitation, fluorine (F; Mw 18.998 g/mol), chlorine (Cl; Mw 35.453 g/mol), bromine (Br; Mw 79.904 g/mol), and iodine (I; 253.8089 g/mol).

As used herein, the term “halide ion” refers to a halogen atom with a negative charge.

As used herein, the term “interhalogen compound” refers to a compound formed from the union of two different halogen atoms. Interhalogen compounds include diatomic halogens (AX), tetratomic halogens (AX₃), hexatomic halogens (AX₅), and octatomic halogens (AX₇). Examples of interhalogen compounds include, without limitation, ICI (chloride monofluoride), IBr (iodine bromide), CIF (chlorine monofluoride), BrF₃ (bromine trifluoride), IF₅ (iodine pentafluoride), and IF₇ (iodine heptafluoride).

As used herein, the term “current collector” refers to a battery part that supports electrode materials and conducts electricity between the electrode and external circuits.

As used herein, the terms “binder material” and “binder” refers to a material that is responsible for holding together the active material particles within the electrode of a battery to maintain a strong connection between the electrode and the contacts. Binder materials are typically inert.

As used herein, the term “electrode layer” refers to a material, such as a binder material, that is coated on a current collector or a previously coated electrode layer.

As used herein, the term “electrolyte” refers to a material that provides for ion transport between the anode and cathode of a battery cell. An electrolyte acts as a medium for ionic conductivity and transport through its interaction with the anode and the cathode. Upon battery charging, an electrolyte facilitates the movement of ions from the cathode to the anode and on discharge, the electrolyte facilitates the movement of ions from the anode to the cathode. In rechargeable batteries, the electrolyte facilitates ion cycling between the anode and the cathode. Liquid electrolytes generally have three components: a solvent, an ionic salt that facilitates electric conductivity, and additives.

As used herein, the term “conductive additive” refers to a carbon-based material that forms a percolating or crystalline network for electron transport in a battery electrode in order to improve the electrode conductivity. By way of example, with the conductive additives “carbon black” versus “conductive carbon black,” conductive carbon black has a higher void volume than carbon black and thus, “conductive carbon black” has a higher electrical conductivity than “carbon black.”

As used herein, the term “electrochemical surface area” or “ECSA” refers to the area of an electrode material that is accessible to the electrolyte that is used for charge transfer and storage. The ECSA of a material is calculated from the charge density obtained from cyclic voltammetry experiments, which measure the charge required to reduce a monolayer of protons on an electrode surface. The surface area of an electrode material may affect how a battery operates. For example, an increase in the surface area of an electrode may increase the current flowing through the cell and the rate of reaction in the cell.

As used herein, the term “S/cm” refers to “siemens per centimeter,” a unit of electric conductivity. A siemens is the International System of Units (SI) unit of electric conductance, susceptance, and admittance, which are the reciprocals of resistance, reactance, and impedance, respectively; thus, one siemens is equal to the reciprocal of one ohm (Ω⁻¹) (also referred to in the art as “mho”-ohm spelled backwards). The SI unit for electrical conductivity is S/m (siemens per meter) (rather than S/cm). Based on the foregoing units, by way of illustration, 5 S/cm=500 S/m=500 mho/m=5 mho/cm=⅕ ohm-cm. S/cm has a dimension of M⁻¹L⁻³T³I², where M is mass, L is length, T is time, and I is electric current.

As used herein, the term “oxidizing gas” refers to a gas that induces a reduction-oxidation (redox) reaction in a battery cell. An oxidizing gas may be any gas with >1% O₂: examples including, without limitation, oxygen, air, nitric oxide, nitrogen dioxide, and combinations thereof. As is known to those of skill in the art, a redox reaction is a reaction that transfers electrons between (i) a reducing agent that undergoes oxidation through the loss of electrons and (ii) an oxidizing agent that undergoes reduction through the gain of electrons. It is to be understood that the oxidizing gas is introduced to the battery within the confines of the sealed battery cell where the battery uses the oxidizing gas to induce the redox reaction that runs the battery. Where the oxidizing gas is air, the battery consumes oxygen from the air to run the redox reaction. In addition to promoting the redox reaction, the oxidizing gas works in concert with the electrolyte described herein to form a stable SEI (solid-electrolyte interphase) layer on the surface of the battery anode.

As used herein, “specific capacity” refers to a measure of an electrode's performance. The specific capacity of an electrode is a measure of the amount of electric charge in milliampere hours (mAh) that the electrode material can deliver per gram (mAh/g) of the material. In lithium-ion batteries, the carrier of the electric charge is the positive charged lithium ion. Specific capacity is one of the key cell performance parameters that are used to measure the rate performance and life cycle of a battery. The life cycle of a battery cell is generally defined as the number of cycles that a battery cell can perform before its capacity drops to 80% of the initial specific capacity.

As used herein, the terms “0.5 C,” “1 C,” and “2 C” refer to a battery “C-rate.” The C-rate of a battery is a measure of the rate at which the battery is being charged/discharged when normalized by its rated capacity. When fully charged, a battery discharged at a rate of 0.5 C should take 2 hours to fully discharge. The absolute discharge current in mA is the discharge current necessary to meet the discharge time criterion and that discharge current is considered to be the 0.5 C rate. Similarly, a battery charged/discharged at 1 C should take 1 hour to fully charge or deplete its full capacity and a battery charged/discharged at 2 C should take 30 minutes to fully charge or deplete its full capacity.

As used herein, the term “overpotential” refers to the condition of a battery that requires more energy than is thermodynamically required to drive a redox reaction. The energy missing from a battery exhibiting overpotential is lost as heat.

As used herein the term “cell impedance” refers to a measure of the internal resistance of battery to the flow of electric current and is measured in ohms (Ω). A battery with low internal resistant delivers high current on demand whereas a battery with high internal resistance causes the battery to heat up and the voltage to drop. Electrical impedance spectroscopy (EIS) is used to obtain impedance characterization of LIBs. To perform an EIS measurement, a set of AC currents with defined amplitudes and frequencies are sequentially applied to the electrochemical system. After measuring the electrical feedback voltage signal, the characterization of the electrical system is obtained, which includes three main regions: a low frequency region, a middle frequency region, and a high frequency region. Impedance spectra may be represented graphically with a Nyquist plot, which measures the stability of a battery with data plotted in four quadrants where the frequency is swept as a parameter resulting in one point per frequency. Each frequency point in the Nyquist plot is plotted with the imaginary part (−Im(Z) on the y-axis and the real part (Re(Z) on the x-axis; the imagery part, which may cross the x-axis, represents the reactance value of the impedance graph. By contrast, the real part represents the transfer function, i.e., the output for each possible input. Stability of the battery is determined by observing the distance between (−1,0) and the point at which the curve crosses the negative real axis. More distance between these two points corresponds to a larger gain margin and consequently, to a more stable battery. Within the context of the present invention, the Nyquist plots will only show the upper right quadrants, which display positive values for the x and y axes.

Described herein is a rechargeable battery with a multi-layer cathode comprising: (1) an anode, (2) a cathode current collector, (3) a cathode comprising (i) at least one halogen or at least one metal halide active material, (ii) a first electrode layer in contact with the current collector, wherein the first electrode layer comprises (a) at least one adhesion promoting binder and (b) at least one conductive additive with an electrochemical surface area ≥800 m²/g and, (iii) a second electrode layer coated over the first electrode layer, wherein the second electrode layer comprises (a) at least one polymeric binder that participates in a complexation interaction with the at last one halogen or at least one metal halide active material and (b) at least one conductive additive with a conductivity ≥5 S/cm and; and (4) an electrolyte in contact with the anode and the cathode. As will be shown herein, the multi-layer cathode produces a rechargeable battery with high-rate capability, high specific capacity, and low cell impedance.

In one embodiment, the halogen or metal halide active material is incorporated into the first layer of the electrode. In another embodiment, the halogen or metal halide active material is incorporated into the second layer of the electrode layer. To facilitate the incorporation, the halogen or metal halide active material is dissolved in a solvent, for example, water or alcohol. In a further embodiment, the first electrode layer is coated onto the current collector and the second electrode layer is coated onto the first electrode layer using the same technique. In another embodiment, the first electrode layer is coated onto the current collector and the second electrode layer is coated onto the first electrode layer with a different technique. Examples of techniques that may be used to coat the first electrode layer onto the current collector and the second electrode layer onto the first electrode layer, include, without limitation, doctor blading, drop casting, spray coating, dip coating, spin coating, roll coating, slot-die coating, bar coating, coated blade spray, electrospray ionization (ESI), desorption electrospray ionization (DESI), and electrohydrodynamic electrospray (EHD).

The multi-layer cathode of the rechargeable battery may have two layers as described above or one or more additional layers that are similar to the second electrode layer. In one embodiment, the one or more additional layers have the same polymeric binder and conductive additive as the second electrode layer. In another embodiment, the one or more additional layers have a different polymeric binder and/or a different conductive additive as the second electrode layer. Where the halogen or metal halide active material is incorporated into the second layer, the one or more additional second layers may not need to include the active material; thus, the additional layers based upon the second layer will comprise the at least one polymeric binder and the at least one conductive additive without the active material.

In a further embodiment, the active material of the battery may be a Group 17 halogen as defined herein.

In another embodiment, the active material of the battery is an interhalogen compound as defined herein. It is to be understood that as used herein, the term “at least one halogen” includes interhalogen compounds within its scope.

In a further embodiment, the active material of the battery is a metal halide comprising an alkali metal or alkaline earth metal as defined herein and a Group 17 halogen as defined herein.

In another embodiment, the metal halide active material comprises an iodide salt, which may be a mono-iodide salt or a poly-iodide salt. Examples of metal halides with mono-iodide salts include, without limitation, LiI, NaI, KI, RbI, CsI, and FrI. Examples of metal halides with poly-iodide salts include, without limitation, BeI₂, MgI₂, CaI₂, SrI₂, BaI₂, and RaI₂. In one embodiment, the active material is the metal halide lithium iodide (LiI).

In a further embodiment, the active material of the battery comprises complexes with more than one metal halide. Examples of such metal halide complexes include, without limitation, LiI+LiBr, LiI+LiCl, LiBr+LiCl, LiI+AlCl, LiBr+AlCl₃, and LiCl+AlCl₃. It is to be understood that as used herein, the term “at least one metal halide” includes metal halide complexes within its scope.

In another embodiment, the active material is dosed into the cathode at a loading percentage >50% of the total cathode weight (inclusive of active material(s), conductive additive(s) and binder(s) exclusive of current collector. In a further embodiment, the active material is dosed into the cathode at a loading percentage of 51-99%. In another embodiment, the active material is dosed into the cathode at a loading percentage of 55-95%. In a further embodiment, the active material is dosed into the cathode at a loading percentage of 60-90%. In another embodiment, the active material is dosed into the cathode at a loading percentage of 65-85%. In a further embodiment, the active material is dosed into the cathode at a loading percentage of 70-80%.

The adhesion promoting binders of the first electrode layer hold the active material particles (if they are present in the first electrode layer) and the conductive additives of the first electrode layer together and in contact with the cathode current collector. Examples of adhesion promoting binders that may be used in the first electrode layer of the multi-layer cathode include, without limitation, sodium carboxymethylcellulose (CMC), styrene-butadiene rubber (SBR), polyvinylidene difluoride (PVDF), polyamide-imide (PAI) resin, and combinations thereof. Where the adhesion promoting binder is PVDF, the PVDF may require dissolution in the solvent n-methyl 2-pyrrolidone (NMP). The combination of water-soluble CMC and SBR may be used together as an aqueous binder where the CMC is the thickening/setting agent and SBR is the primary binder.

Examples of conductive additives with ECSA ≥800 m²/g that may be used in the first electrode layer include, without limitation, graphene (ECSA 800-2650 m²/g), carbide-derived carbon (ECSA ˜2000 m²/g), conductive carbon black (ECSA up to 1500 m²/g), Ketjen black (ECSA 800-1400 m²/g), and combinations thereof. The synthesis of additional high surface area conductive additives with ECSA ≥800 m²/g will be within the skill level of those of ordinary skill in the art. For example, activated carbon, which has an ECSA of ˜50 m²/g, may be treated with NaOH and pyrolysis at high temperature (e.g., 700-800° C.) to produce high surface area activated carbon with an ECSA ≥800 m²/g.

The polymeric binders of the second electrode layer hold the active material particles (if they are present in the first electrode layer) and the conductive additives of the second electrode layer together. Chemically, the polymeric binders of the second electrode layer interact with the active material to form a complex between the polymeric binder and the active material via ionic or other coulombic interactions. Examples of polymeric binders that may be used for the second electrode layer of the multi-layer cathode include, without limitation, amylose, amylopectin, cellulose, xylan, chitin, chitosan, alginic acid, glycogen, poly(vinyl) acetate (PVAc), poly(vinyl) alcohol (PVA), poly(vinyl) pyrrolidone (PVP), nylon, polyaniline (PANI), polypyrrole (PPy), poly(vinyl) pyridine, polyacrylonitrile (PAN), polyacetylene (PA), poly phenylacetylene (PPA), polyphenylene vinylene (PPV), polythiophene (PT), alpha-cyclodextrin, beta-cyclodextrin, poly(3,4-ethyenedioxythiophene) polystyrene sulfonate (PEDOT: PSS), poly(2-dimethylamino)ethyl methacrylate) methyl chloride quaternary salt (MADQUAT), poly(diallyl dimethylammonium chloride) (PDADMAC), and combinations thereof.

Examples of conductive additives with a conductivity ≥5 S/cm that may be used in the second electrode layer include, without limitation, conductive carbon black (10-1012 S/cm), single-walled carbon nanotubes (up to 107 S/cm), graphite (up to 25000 S/cm), graphene (10-1000° S/cm), carbon black (up to 100 S/cm), activated carbon (up to 100 S/cm) (includes “super activated carbon,” which is activated carbon that is microporous, a powder, or in the form of nanoparticles), carbon fibers, carbide-derived carbon (20-35 S/cm), Ketjen black (up to 10 S/cm), and combinations thereof. The modification of the electrical conductivity of conductive additives will be within the skill level of those of ordinary skill in the art. For example, where necessary, the electrical conductivity of a conductive additive may be adjusted by combining one or more conductive additives (typically will increase electrical conductivity of an additive); agglomerating the additive to lose its crystallinity (which may decrease the electrical conductivity of an additive); or by reducing or increasing the proportion of the conductive additive relative to the surface area and electrolyte adsorption capacity of the electrode to which the conductive additive is to be applied.

In another embodiment, the electrode layers of the multi-layer cathode are prepared as slurries using only water and/or alcohol. With reference to Example 1, the microporous super activated carbon (MSC-30SS), Ketjen black, SBR, and CMC of the first electrode layer are mixed into a slurry with deionized water and the Ketjen black and PVP of the second slurry are also mixed with deionized water. The LiI, which is dosed onto the first electrode layer, is dissolved for application with ethanol. The use of only water and alcohol to prepare the electrode layers and active agent for dosing improves upon the manufacture of currently used rechargeable batteries, which use N-methyl-2-pyrrolidone (NMP) solvents.

Examples of materials that may be used for the anode include, without limitation, carbon, graphite, silicon, lithium (Li), sodium (Na), potassium (K), calcium (Ca), zinc (Zn), aluminum (Al), vanadium (V), iron (Fe), and combinations thereof.

Examples of materials that may be used as the cathode current collector include, without limitation, aluminum (Al) (e.g., aluminum foil), copper (Cu), nickel (Ni), titanium (Ti), stainless steel, and combinations thereof.

The electrolyte for use with the rechargeable battery described herein is a liquid electrolyte comprising at least one organic solvent and at least one ionic salt. Examples of organic solvents that may be used in the electrolyte include, without limitation, 1,2-dimethoxyethane (DME), tetraglyme (G4), 1,3-dioxolane (DOL), tetrahydrofuran (THF), ethyl acetate, acetonitrile, dimethylformamide (DMF), dimethyl sulfoxide (DMSO), acetone, hexamethylphosphoric triamide (HMPA), and combinations thereof. Examples of ionic salts that may be used in the electrolyte include, without limitation, lithium nitrate (LiNO₃), lithium bix (oxalate)-borate (LiBOB), lithium bis(trifluoromethanesulfonyl)imide (LiTFSI), lithium bis(fluorosulfonyl)imide (LiFSI), lithium hexafluorophosphate (LiPF₆), and combinations thereof.

In one embodiment, the battery comprises an oxidizing gas that is enclosed within the battery cell and has contact with the anode, the cathode, and the electrolyte. Examples of oxidizing gases that may be used with the rechargeable battery described herein include, without limitation, oxygen, air, nitric oxide, nitrogen dioxide, and combinations thereof. While not wishing to be bound by theory, it is believed that the oxygen, or another oxidizing gas, may be infused or incorporated into the cell during cell assembly, and under a dry air environment may react with the metal and the electrolyte molecules at the anode resulting in the formation of a protective SEI passivation layer on the anode surface.

Once the interhalogen cathode, the anode, and the electrolyte formulation are prepared, the battery components may be assembled in a battery container, such as for example, a CR2032 type button cell, a CR2032 type coin cell, a Swagelok cell, a cylindrical cell, a prismatic cell, or a pouch cell. The internal infrastructure of the battery cell allows for the containment of an oxidizing gas within the battery cell at fabrication, thus, eliminating the need for external infrastructure to manage gas generation and materials flow. The lack of external infrastructure for introduction of the oxidizing gas into the battery stack makes the multi-layer cathode battery described herein suitable for mobility applications, such as portable electronic device or electric vehicles.

A rechargeable battery prepared with the high active material loading multi-layer cathode described herein has high-rate capability, high specific capacity, and low cell impedance. In one embodiment, the battery has a specific capacity in the range of 80-200 mAh/g. In another embodiment, the battery has a specific capacity of approximately 150 mAh/g at 2 C rate. In a further embodiment, the battery maintains a specific capacity of approximately 80-110 mAh/g and a % efficiency of 90-99% for multiple cycles post-formation. In another embodiment, the battery maintains a specific capacity of approximately 85-105 mAh/g for at least 50 cycles. In a further embodiment, the battery maintains a % efficiency of 95-99% for approximately 200 cycles. In another embodiment, the battery has low internal resistance and high capacitance at 1 C rate. In a further embodiment, the battery has an internal resistance of 50-175Ω at 1 C rate. In another embodiment, the battery has an internal resistance of 50-150Ω at 1 C rate. In a further embodiment, the internal resistance of the battery approaches zero after multiple cycles at 1 C rate.

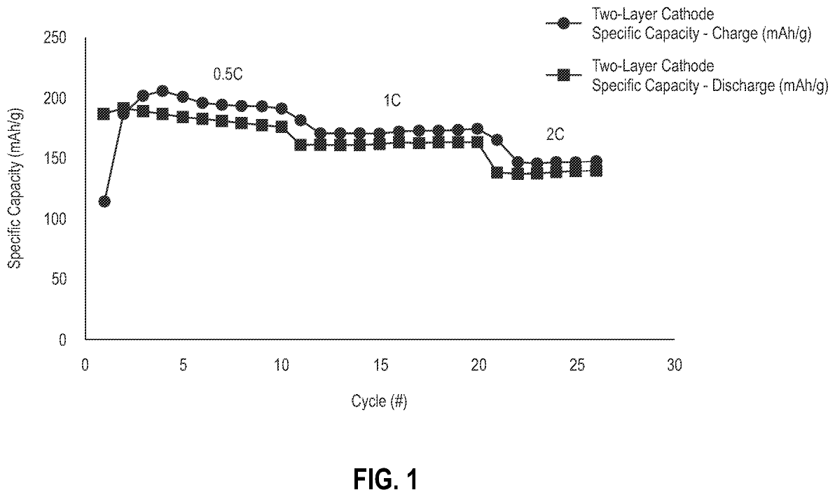

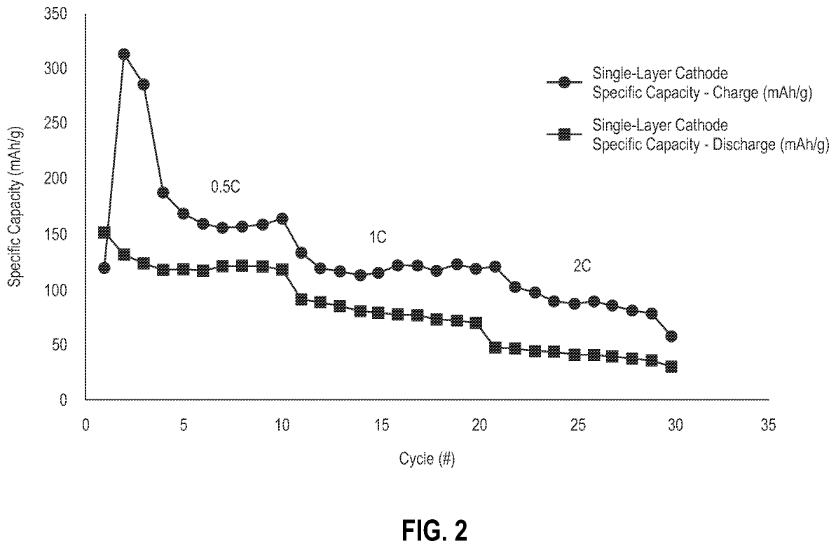

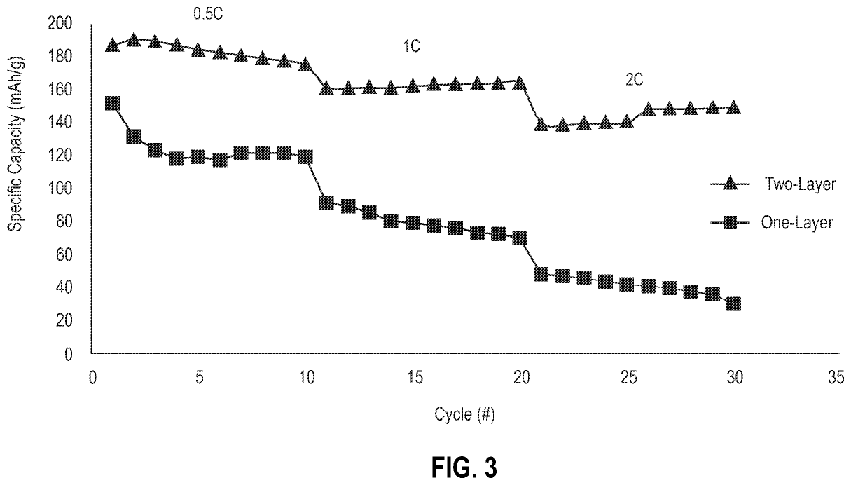

FIG. 1 is a rate performance graph showing the specific capacity (mAh/g) at rates 0.5 C, 1 C, and 2 C for a battery with a two-layer cathode prepared according to the procedure of Example 1 with 60% LiI active material loading over 26 cycles. FIG. 2 is a rate performance graph showing the specific capacity (mAh/g) at rates 0.5 C, 1 C, and 2 C for a battery with a single-layer cathode prepared according to the procedure of Comparative Example 1 with 64% LiI active material loading over 26 cycles. FIG. 3 is a rate performance graph that overlays the specific capacity curves of FIGS. 1 and 2 in order to show the improved specific capacity of the battery fabricated with the two-layer cathode. As shown in FIG. 3, the specific capacity at rates 0.5 C, 1 C, and 2 C for the battery with the two-layer cathode is 180, 160, and 150 mAh/g, respectively, versus the much lower values of 120, 80, and 0.4 mAh, respectively, for the battery with the single-layer cathode. The data in FIGS. 1-3 show that even when a single layer cathode has higher active material loading that its two-layer counterpart, the two-layer cathode as described herein shows improved battery performance through at least rate 2 C in comparison to the single-layer cathode.

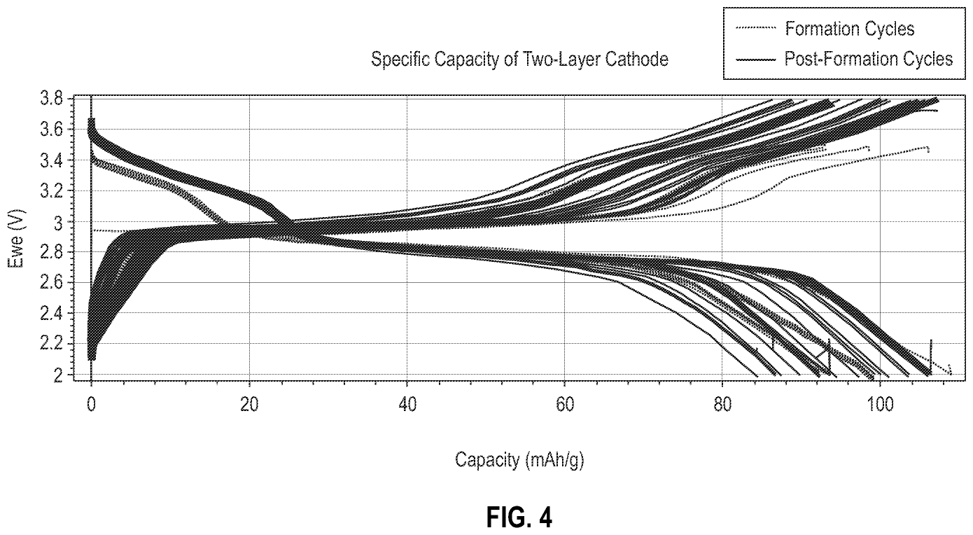

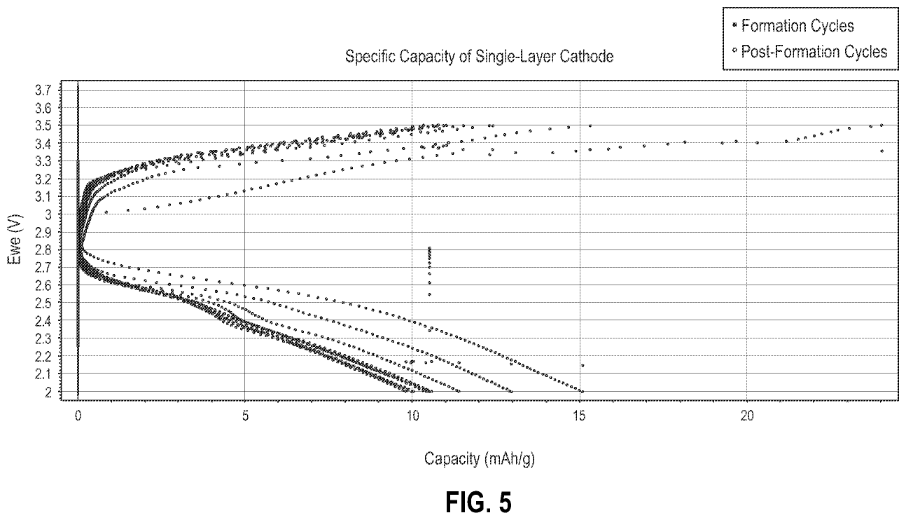

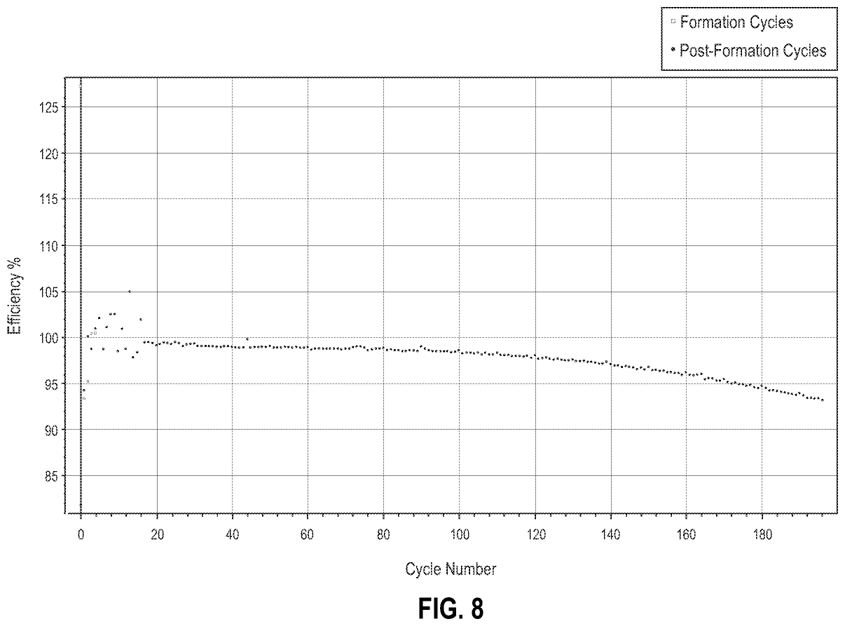

FIG. 4 is a graph showing specific capacity of a battery with the two-layer cathode described in Example 1 with 71% LiI active material loading and FIG. 5 is a graph showing specific capacity of a battery with the single-layer cathode described in Comparative Example 1 with 74% LiI active material loading. In FIGS. 4 and 5, the solid and dashed curves represent charge/discharge cycles performed at different rates with the dashed curves representing formation cycles carried out a 2-2.5V at 0.5 C rate and the curves representing subsequent cycles carried out at 2-3.8V at 1 C rate. During the initial ten formation cycles, the battery with the two-layer cathode (FIG. 4) achieves high specific capacities ranging from ˜87-105 mAh/g. The high specific capacity of the battery with the two-layer cathode is maintained during the subsequent post-formation cycles where the battery achieves specific capacities ranging from ˜82-103 mAh/g over 29 cycles. FIG. 8 shows that when the battery of FIG. 4 is charged/discharged for a total of 196 cycles, the coulombic efficiency of the battery after the first few cycles is 99% and is only slightly reduced to 94% efficiency at cycle 196. By contrast, the battery with the single-layer cathode (FIG. 5) only achieved a specific capacity of ˜15 mAh/g over 10 formation cycles and failed to cycle post-formation. The low specific capacity of the formation cycles of the battery with the single-layer cathode indicates that this battery underwent a high overpotential at the 0.5 C rate leading the battery to produce no capacity at the 1 C rate due to poor conductivity and high cell resistance.

The data in FIGS. 4, 5, and 8 also demonstrate that high active material loading alone does not lead to improved battery performance. While the battery with the single-layer cathode had higher active material loading (LiI loading at 74%) than the battery with the two-layer cathode (LiI loading at 71%), the battery with the single-layer cathode had poor performance at the formation cycles and failed to cycle at all post-formation.

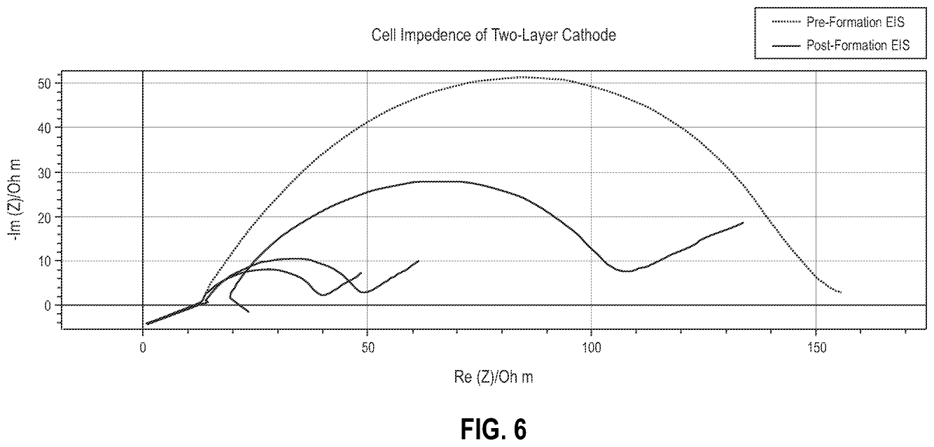

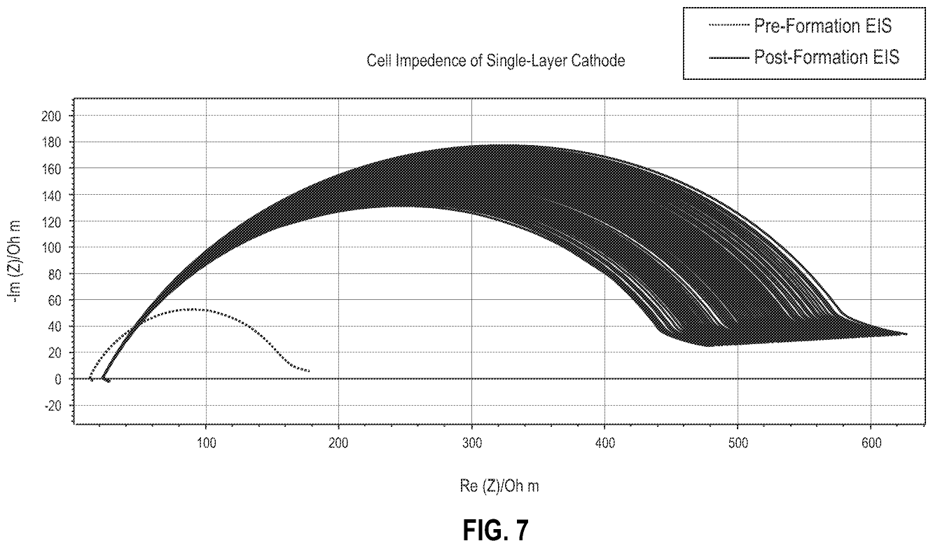

FIG. 6 is a graph showing the cell impedance of the battery with the two-layer cathode described in Example 1 with 71% LiI loading (i.e., the same battery with the specific capacity data of FIG. 4) and FIG. 7 is a graph showing cell impedance of the single layer cathode described in Comparative Example 1 with 74% LiI active material loading (i.e., the same battery with the specific capacity data of FIG. 5). FIGS. 6 and 7 only show the positive quadrant of the EIS cell impedance graph. The experimental steps in FIGS. 6 and 7 are as follows:
1. Pre-formation EIS
2. Formation Cycles at 0.5 C rate
3. Post-formation EIS
4. Post-formation Cycles at 1 C rate
5. Loop back to 3.

In FIG. 6, the rechargeable battery with the two-layer cathode has a pre-formation EIS of ˜156Ω. After ten formation cycles at 0.5 C rate, the internal resistance of the battery is reduced to ˜133Ω. Following the formation cycles, the electrochemistry of the battery is initiated and after the first set of ten post-formation cycles is completed, the internal resistance of the battery is further reduced to ˜61Ω. After the completion of a second set of ten post-formation cycles, the internal resistance of the battery has an EIS of ˜48Ω. The reduction in the internal resistance of the battery with the two-layer cathode from pre-formation through the final post-formation cycle demonstrates that this battery is highly stable.

In FIG. 7, the rechargeable battery with the single-layer cathode has a pre-formation EIS of ˜179Ω, which is higher, but comparable to the pre-formation EIS of the battery with the two-layer cathode, and also expected since most batteries have approximately the same resting resistance. After ten formation cycles at 0.5 C rate, the internal resistance of the battery significantly increases to ˜480Ω. Following the formation cycles, the electrochemistry of the battery is initiated and the battery undergoes a series of post-formation cycles where the internal resistance of the battery is measured after each set of ten post-formation cycles. The final internal resistance measure for the battery with the single-layer cathode is an EIS of ˜623Ω. Since the battery with the single-layer cathode has no capacity at the 1 C rate (as is shown in FIG. 5), the 1 C cycles occur quickly and in succession. The significant increase in the internal resistance of the battery with the one-layer cathode from pre-formation through the final post-formation demonstrates that this battery is highly unstable.

The data provided herein shows that unlike rechargeable batteries with single-layer cathodes, the rechargeable battery with the two-layer cathode is a highly stable battery that simultaneously achieves high capacity and a high charging rate while offering high loading (>10 mg/cm²) and a high wt % (>50%) of active material in the cathode.

The descriptions of the various aspects and/or embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the aspects and/or embodiments, the practical application or technical improvement over technologies found in the art, or to enable others of ordinary skill in the art to understand the aspects and/or embodiments disclosed herein.

### EXPERIMENTAL

The following examples are set forth to provide those of ordinary skill in the art with a complete disclosure of how to make and use the aspects and embodiments of the invention as set forth herein. While efforts have been made to ensure accuracy with respect to variables such as amounts, temperature, etc., experimental error and deviations should be considered. Unless indicated otherwise, parts are parts by weight, temperature is degrees centigrade, and pressure is at or near atmospheric. All components were obtained commercially unless otherwise indicated.

In the following Examples, all salts were dried at 150° C. inside of an argon filled glovebox and stored at 100° C. inside of an argon filled glovebox. All solvents were dried over 3 Å molecular sieves for at least 48 hours before use.

### Example 1

### Preparation of Two-Layer Cathode

An electrolyte was prepared by weighing 0.5 mmol LiTFSI (lithium bis(trifluoromethanesulfonyl)imide) and 0.2 mmol LiNO₃ (lithium nitrate) and dissolving the salts into 500 μL of DME (1,2-dimethoxyethane) to which a further 500 μL of DOL (1,3-dioxolane) was added. The final solution was clear, colorless, and without visible undissolved salt.

A cathode film was prepared with a piece of stainless-steel foil washed with isopropyl alcohol and dried at 100° C. A first slurry for application to the cathode film was prepared from the following materials: 76.5% MSC-30SS (microporous super activated carbon; Kansai Coke Chemical Company, Amagasaki, Hyogo, Japan); 8.5% Ketjen black (Lion Specialty Chemicals Co., Ltd., Sumida, Tokyo, Japan); 13% SBR (styrene-butadiene rubber; Targray, Kirkland, Quebec, Canada); and 2% CMC (sodium carboxymethyl cellulose; Sigma-Aldrich, Burlington, Massachusetts, USA). The first slurry materials were mixed in DI-H₂O resulting in a slurry with a solids content of 22% and 78% water by weight. The first slurry was coated onto the stainless-steel foil by doctor blading to form a first electrode layer. The cathode film with the first electrode layer was then dried at 120° C. and transferred into an inert argon environment (N₂, clean-dry air, etc. could also be used) where LiI (lithium iodide) in EtOH (ethanol) was dosed onto the cathode film. Following the application of the LiI/EtOH, the cathode film was heated a second time to 120° C.-150° C. to drive off any residual moisture and a second slurry was prepared with the following materials: ethanol (50-97%), Ketjen black (2-49%) (Lion Specialty Chemicals Co., Ltd., Sumida, Tokyo, Japan), and polyvinylpyrrolidone (PVP; 1-20%). The second slurry materials were mixed until the desired consistency was achieved. The second slurry was then coated as a second electrode layer on top of the first electrode layer.

A battery stack was assembled in an atmosphere of clean, dry air with 21% O₂ and 79% N₂. A lithium metal anode was affixed to a stainless-steel current collector and placed in contact with a stainless-steel cell casing. 30 μL of electrolyte was applied to the lithium metal anode onto which a polyethylene-polypropylene-polyethylene separator CELGARD® 2325; Celgard, LLC, Charlotte, N.C., USA) was placed. An additional 30 μL of electrolyte was applied to the separator and the two-layer cathode prepared as described herein was placed, cathode side down, onto the stack assembly. Upon completion of the battery stack, the stack was contained in a 2032 type coin cell and the cell was sealed.

FIG. 1 shows the specific capacity at discharge/charge over 26 cycles for a battery with the two-layer cathode at a LiI loading of 60% and FIGS. 4 and 6 show the specific capacity (FIG. 4) and cell impedance (FIG. 6) of a battery with the two-layer cathode at a LiI loading of 71%.

### Comparative Example 1

### Preparation of Single-Layer Cathode

An electrolyte was prepared by weighing 0.5 mmol LiTFSI (lithium bis(trifluoromethanesulfonyl)imide) and 0.2 mmol LiNO₃ (lithium nitrate) and dissolving the salts into 500 μL of DME (1,2-dimethoxyethane) to which a further 500 μL of DOL (1,3-dioxolane) was added. The final solution was clear, colorless, and without visible undissolved salt.

A cathode was prepared with a piece of stainless-steel foil washed with isopropyl alcohol and dried at 100° C. The slurry was prepared from the following materials: 76.5% MSC-30SS (microporous super activated carbon; Kansai Coke Chemical Company, Amagasaki, Hyogo, Japan); 8.5% Ketjen black (Lion Specialty Chemicals Co., Ltd., Sumida, Tokyo, Japan); 13% SBR (styrene-butadiene rubber; Targray, Kirkland, Quebec, Canada); and 2% CMC (sodium carboxymethyl cellulose; Sigma-Aldrich, Burlington, Massachusetts, USA). To make the slurry, the materials were mixed in DI-H₂O resulting in a slurry with a solids content of 22% and 78% water by weight. The cathode film was then dried at 120° C. and transferred into an inert argon environment (N₂, clean-dry air, etc. could also be used) where LiI (lithium iodide) in EtOH (ethanol) was dosed onto the cathode film. Following the application of the LiI/EtOH, the cathode film was heated a second time to 120° C.-150° C. to drive off any residual moisture and.

A battery stack was assembled in an atmosphere of clean, dry air with 21% O₂ and 79% N₂. A lithium metal anode was affixed to a stainless-steel current collector and placed in contact with a stainless-steel cell casing. 30 μL of electrolyte was applied to the lithium metal anode onto which a polyethylene-polypropylene-polyethylene separator CELGARD® 2325; Celgard, LLC, Charlotte, N.C., USA) was placed. An additional 30 μL of electrolyte was applied to the separator and the single-layer cathode prepared as described herein was placed, cathode side down, onto the stack assembly. Upon completion of the battery stack, the stack was contained in a 2032 type coin cell and the cell was sealed.

FIG. 2 shows the specific capacity at discharge/charge over 26 cycles for a battery with the single-layer cathode with at a LiI loading of 64% and FIGS. 5 and 7 show the specific capacity (FIG. 5) and cell impedance (FIG. 7) of a battery with the single-layer cathode at a LiI loading of 74%.

We claim:

1. A rechargeable battery comprising:
an anode;
a cathode current collector;
a multi-layer cathode comprising (i) at least one halogen or metal halide active material, (ii) a first electrode layer in contact with the cathode current collector, wherein the first electrode layer comprises at least one adhesion promoting binder and at least one first conductive additive with an electrochemical surface area ≥800 m²/gm, and (iii) a second electrode layer coated over the first electrode layer, wherein the second electrode layer comprises at least one polymeric binder that participates in a complexation interaction with the at least one halogen or metal halide active material and at least one second conductive additive with a conductivity ≥5 S/cm; and
an electrolyte in contact with the anode and the cathode.

2. The battery of claim 1, wherein the at least one adhesion promoting binder of the first electrode layer is selected from the group consisting of sodium carboxymethylcellulose (CMC), styrene-butadiene rubber (SBR), polyvinylidene difluoride (PVDF), polyamide-imide (PAI) resin, and combinations thereof.

3. The battery of claim 1, wherein the at least one first conductive additive of first electrode layer is selected from the group consisting of graphene, conductive carbon black, carbide-derived carbon, Ketjen black, and combinations thereof.

4. The battery of claim 1, wherein the at least one polymeric binder of the second electrode layer is selected from the group consisting of amylose, amylopectin, cellulose, xylan, chitin, chitosan, alginic acid, glycogen, poly(vinyl) acetate (PVAc), poly(vinyl) alcohol (PVA), poly(vinyl) pyrrolidone (PVP), nylon, polyaniline (PANI), polypyrrole (PPy), poly(vinyl) pyridine, polyacrylonitrile (PAN), polyacetylene (PA), poly phenylacetylene (PPA), polyphenylene vinylene (PPV), polythiophene (PT), alpha-cyclodextrin, beta-cyclodextrin, poly(3,4-ethyenedioxythiophene) polystyrene sulfonate (PEDOT: PSS), poly(2-dimethylamino)ethyl methacrylate) methyl chloride quaternary salt (MADQUAT), poly(diallyl dimethylammonium chloride) (PDADMAC), and combinations thereof.

5. The battery of claim 1, wherein the at least one second conductive additive of the second electrode layer is selected from the group consisting of conductive carbon black, single-walled carbon nanotubes, graphite, graphene, carbon black, activated carbon, carbon fibers, carbide-derived carbon, Ketjen black, and combinations thereof.

6. The battery of claim 1, wherein the at least one halogen or metal halide active material is incorporated into the first electrode layer.

7. The battery of claim 1, wherein the at least one halogen or metal halide active material is incorporated into the second electrode layer.

8. The battery of claim 1, wherein the multi-layer cathode includes one or more additional electrode layers having a composition similar to the second electrode layer.

9. The battery of claim 1, further comprising an oxidizing gas in contact with the anode, the cathode, and the electrolyte.

10. The battery of claim 9, wherein the oxidizing gas is selected from the group consisting of oxygen, air, nitric oxide, nitrogen dioxide, and combinations thereof.

11. The battery of claim 1, wherein the active material is a metal halide with a mono-iodide or poly-iodide salt.

12. The battery of claim 1, wherein the electrolyte is a liquid electrolyte comprising at least one organic solvent and at least one ionic salt.

13. The battery of claim 10, wherein the at least one organic solvent is selected from the group consisting of 1,2-dimethoxyethane (DME), tetraglyme (G4), 1,3-dioxolane (DOL), tetrahydrofuran (THF), ethyl acetate, acetonitrile, dimethylformamide (DMF), dimethyl sulfoxide (DMSO), acetone, hexamethylphosphoric triamide (HMPA), and combinations thereof.

14. The battery of claim 10, wherein the ionic salt is selected from the group consisting of lithium nitrate (LiNO₃), lithium bix (oxalate)-borate (LiBOB), lithium bis(trifluoromethanesulfonyl)imide (LiTFSI), lithium bis(fluorosulfonyl)imide (LiFSI), lithium hexafluorophosphate (LiPF₆), and combinations thereof.

15. The battery of claim 1, wherein the anode comprises a material selected from the group consisting of carbon, graphite, silicon, lithium (Li), sodium (Na), potassium (K), calcium (Ca), zinc (Zn), aluminum (Al), vanadium (V), iron (Fe), and combinations thereof.

16. The battery of claim 1, wherein the cathode current collector comprises a material selected from the group consisting of aluminum (Al), copper (Cu), nickel (Ni), titanium (Ti), stainless steel, and combinations thereof.

17. A rechargeable battery comprising:
a lithium-containing anode;
a stainless-steel cathode current collector;
a two-layer cathode comprising (i) lithium iodide as an active cathode material, (ii) a first electrode layer in contact with the cathode current collector, wherein the first electrode layer comprises at least two adhesion promoting binders and at least two first conductive additives with an electrochemical surface area ≥800 m²/gm, and (iii) a second electrode layer coated over the first electrode layer, wherein the second electrode layer comprises at least one polymeric binder that participates in a complexation interaction with the lithium iodide active material and at least one second conductive additive with a conductivity ≥5 S/cm; and an electrolyte in contact with the anode and the cathode;
a liquid electrolyte comprising at least one organic solvent and at least one ionic salt in contact with the anode and the cathode; and
an oxidizing gas in contact with the anode, the cathode, and the liquid electrolyte.

18. The battery of claim 15, wherein the at least two adhesion promoting binders of the first electrode layer are sodium carboxymethylcellulose and styrene-butadiene rubber.

19. The battery of claim 15, wherein the at least two first conductive additives of first electrode layer are graphene and Ketjen black.

20. The battery of claim 15, wherein the at least one polymeric binder of the second electrode layer is poly(vinyl) pyrrolidone (PVP).

21. The battery of claim 15, wherein the at least one second conductive additive of the second electrode layer is Ketjen black.

22. The battery of claim 15, wherein the lithium iodide active cathode material is incorporated into the first electrode layer.

23. The battery of claim 15, wherein the lithium iodide active cathode material is incorporated into the second electrode layer.

24. A method of fabricating a multi-layer cathode for a rechargeable battery comprising:
preparing a first slurry comprising at least one adhesion promoting binder and at least one first conductive additive with an electrochemical surface area ≥800 m²/gm;
dosing at least one halogen or metal halide active material solubilized in water or alcohol into the first slurry;
applying the first slurry with the active material to a cathode current collector to form a first electrode layer of a multi-layer cathode;
preparing a second slurry comprising at least one polymeric binder and at least one second conductive additive with a conductivity ≥5 S/cm; and
coating the second slurry over the first electrode layer to form a second electrode layer of the multi-layer cathode.

25. A method of fabricating a multi-layer cathode for a rechargeable battery comprising:
preparing a first slurry comprising at least one adhesion promoting binder and at least one first conductive additive with an electrochemical surface area ≥800 m²/gm;
applying the first slurry to a cathode current collector to form a first electrode layer of a multi-layer cathode;
preparing a second slurry comprising at least one polymeric binder, at least one second conductive additive with a conductivity ≥5 S/cm, and at least one halogen or metal halide active material solubilized in water or alcohol; and
coating the second slurry over the first electrode layer to form a second electrode layer of the multi-layer cathode.
